(19) United States
(12) Patent Application Publication
(10) Pub. No.: US 2020/0356021 A1
(43) Pub. Date: Nov. 12, 2020

(54) SECONDARY TRANSFER DEVICE

(71) Applicant: Konica Minolta, Inc., Tokyo (JP)

(72) Inventors: Hiroyuki UI, Tokyo (JP); Kenichi TANAKA, Saitama-shi (JP)

(21) Appl. No.: 16/849,423

(22) Filed: Apr. 15, 2020

(30) Foreign Application Priority Data
May 7, 2019 (JP) 2019-087307
May 7, 2019 (JP) 2019-087308

(51) Int. Cl. G03G 15/01; G03G 15/16

(52) U.S. Cl. CPC G03G 15/0131; G03G 2215/00139; G03G 15/1605

(57) ABSTRACT

There is provided a secondary transfer device for secondary-transferring a toner image primary-transferred on an outer peripheral surface of an endless annular intermediate transfer belt to a sheet at a predetermined secondary transfer position, the intermediate transfer belt having a predetermined width and being wound around a plurality of rollers and rotating, the secondary transfer device including: a pressure-releasing mechanism that displaces a secondary transfer roller to a pressing position and a separation position; a first drive that drives the pressure-releasing mechanism; a high-speed depressurization mechanism that temporarily depressurizes a nip pressure, at which the secondary transfer roller at the pressing position interposes and presses the intermediate transfer belt in a gap with respect to the opposite roller, when a leading end and a tailing end of a sheet pass between the secondary transfer roller and the intermediate transfer belt; and a second drive that drives the high-speed depressurization mechanism.

The entire disclosures of Japanese patent Application Nos. 2019-087307 and 2019-087308, both filed on May 7, 2019, are incorporated herein by reference in its entirety.

### BACKGROUND

### Technological Field

The present invention relates to a secondary transfer device for secondary-transferring a toner image primary-transferred onto an intermediate transfer belt to a sheet, and more particularly, to a secondary transfer device that can alleviate an impact when the leading and trailing ends of the sheet pass through a secondary transfer position.

### Description of the Related Art

Many electrophotographic image forming apparatuses adopt a configuration in which image forming units for respective color components such as yellow (Y), magenta (M), cyan (C), black (K) are arranged to form each toner image along an outer peripheral surface of an endless annular intermediate transfer belt that has a predetermined width and that is wound around a plurality of rollers and rotates. These image forming units sequentially superimpose the toner images of respective colors on the intermediate transfer belt to form a full-color color toner image on the intermediate transfer belt, and secondary-transfers the image to a sheet.

At the secondary transfer position, a transfer nip is formed by interposing the intermediate transfer belt between a roller that supports the intermediate transfer belt from the inside thereof and a secondary transfer roller that is pressed from outside by a spring or the like. When the transported sheet passes through the transfer nip (between the outer peripheral surface of the intermediate transfer belt and the secondary transfer roller), the toner image on the intermediate transfer belt is transferred to the sheet.

When the leading edge of a cardboard enters the transfer nip or when the trailing edge exits the transfer nip, the load changes greatly. Therefore, the revolving speed of the intermediate transfer belt fluctuates or swing occurs, which may cause streaks or unevenness in the image.

In order to cope with this problem, the nip pressure is temporarily reduced when the leading and trailing ends of the sheet pass through the transfer nip. For example, in the apparatus disclosed in Japanese Patent Application Laid-Open No. 2010-204259, a cam is provided coaxially with the axis of a roller disposed opposite to a secondary transfer roller with an intermediate transfer belt interposed therebetween. The nip pressure is temporarily reduced by increasing the distance between the secondary transfer roller and the roller facing the secondary transfer roller by bringing a convex portion of the cam to contact a contact member provided on the shaft of the transfer roller.

Further, in the device disclosed in Japanese Patent Application Laid-Open No. 2017-83503, the driving force of the motor is transmitted to the secondary transfer roller by a transmission mechanism, and the secondary transfer roller is pressed toward the intermediate transfer belt, and temporary depressurization is performed by controlling the torque of the motor. The transmission mechanism of this device is configured by a first lever and a second lever which are substantially horizontally long, one end of the first lever is pivotally supported (fulcrum), and the secondary transfer roller is pivotally supported in the middle (working point), and the other end is pivotally supported by a slide hole (the working point of the second lever) provided at the tip of the second lever. The second lever is pivotally supported at a position slightly closer to the front end as a fulcrum from the middle portion, and the other end is a force point receiving a force from the motor.

Specifically, the other end of the second lever is spread in a fan shape, and a tooth row that meshes with a gear provided on the shaft of the motor is arranged in an arc shape here. The first lever and the second lever form a link mechanism, and when the second lever swings according to the rotation angle of the motor shaft, the secondary transfer roller is vertically displaced. The transfer nip is formed by driving the motor to press the secondary transfer roller against the intermediate transfer belt. The secondary transfer roller is stationary with the force of the secondary transfer roller pushed back from the intermediate transfer belt and the motor torque balanced, and the motor torque is temporarily reduced when the leading and trailing ends of the sheet pass through the transfer nip, so that the nip pressure is reduced.

In the apparatus disclosed in Japanese Patent Application Laid-Open No. 2010-204259, a cam and a driving unit thereof are provided coaxially with the axis of the roller facing the secondary transfer roller with the intermediate transfer belt interposed therebetween. Therefore, the device configuration becomes large in a long axial direction of the secondary transfer roller.

Further, in the apparatus disclosed in Japanese Patent Application Laid-Open No. 2017-83503, the working point of the depressurization mechanism (second lever) is outside the fulcrum and the working point (the position of the secondary transfer roller) of the pressing mechanism (first lever). The device area in the cross section perpendicular to the axis of the secondary transfer roller is increased.

### SUMMARY

The invention has been made to solve the above problem, and an object of the invention is to provide a secondary transfer device capable of reducing the size while having a function of temporarily reducing a nip pressure when the leading and trailing ends of a sheet pass through a transfer nip.

To achieve the abovementioned object, according to an aspect of the present invention, there is provided a secondary transfer device for secondary-transferring a toner image primary-transferred on an outer peripheral surface of an endless annular intermediate transfer belt to a sheet at a predetermined secondary transfer position, the intermediate transfer belt having a predetermined width and being wound around a plurality of rollers and rotating, and the secondary transfer device reflecting one aspect of the present invention comprises: a pressure-releasing mechanism that displaces a secondary transfer roller to a pressing position where the intermediate transfer belt is interposed and pressed between the secondary transfer roller and an opposite roller that abuts an inner peripheral surface of the intermediate transfer belt at the secondary transfer position, and a separation position separated from the outer peripheral surface of the intermediate transfer belt; a first drive that drives the pressure-releasing mechanism;

a high-speed depressurization mechanism that temporarily depressurizes a nip pressure, at which the secondary transfer roller at the pressing position interposes and presses the intermediate transfer belt in a gap with respect to the opposite roller, when a leading end and a tailing end of a sheet pass between the secondary transfer roller and the intermediate transfer belt; and a second drive that drives the high-speed depressurization mechanism, wherein the pressure-releasing mechanism and the high-speed depressurization mechanism are arranged such that projected images when projected in an axial direction of the secondary transfer roller overlap.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a mechanical schematic configuration of an image forming apparatus including a secondary transfer device according to an embodiment of the invention;

FIG. 2 is a left side view of the secondary transfer device;

FIG. 3 is a diagram corresponding to a cross section taken along line A-A of FIG. 2;

FIG. 4 is a diagram corresponding to a cross section taken along line B-B of FIG. 2;

FIG. 5 is a perspective view illustrating each part of a secondary transfer unit separately;

FIG. 6 is a diagram illustrating a main part of the secondary transfer device at the time of separation;

FIG. 7 is a diagram illustrating a main part of the secondary transfer device at the time of pressure bonding;

FIG. 8 is a diagram illustrating a main part of the secondary transfer device at the time of depressurization;

FIG. 9 is an explanatory diagram illustrating how a first drive and a second drive overlap;

FIG. 10 is a diagram illustrating a secondary transfer device having a configuration in which only one depressurization cam is disposed at the center in the front-rear direction; and

FIGS. 11A and 11B are diagrams illustrating a comparison between a normal state and a state in which a lock mechanism is released and a rotation shaft is moved.

### DETAILED DESCRIPTION OF EMBODIMENTS

Hereinafter, one or more embodiments of the present invention will be described with reference to the drawings. However, the scope of the invention is not limited to the disclosed embodiments.

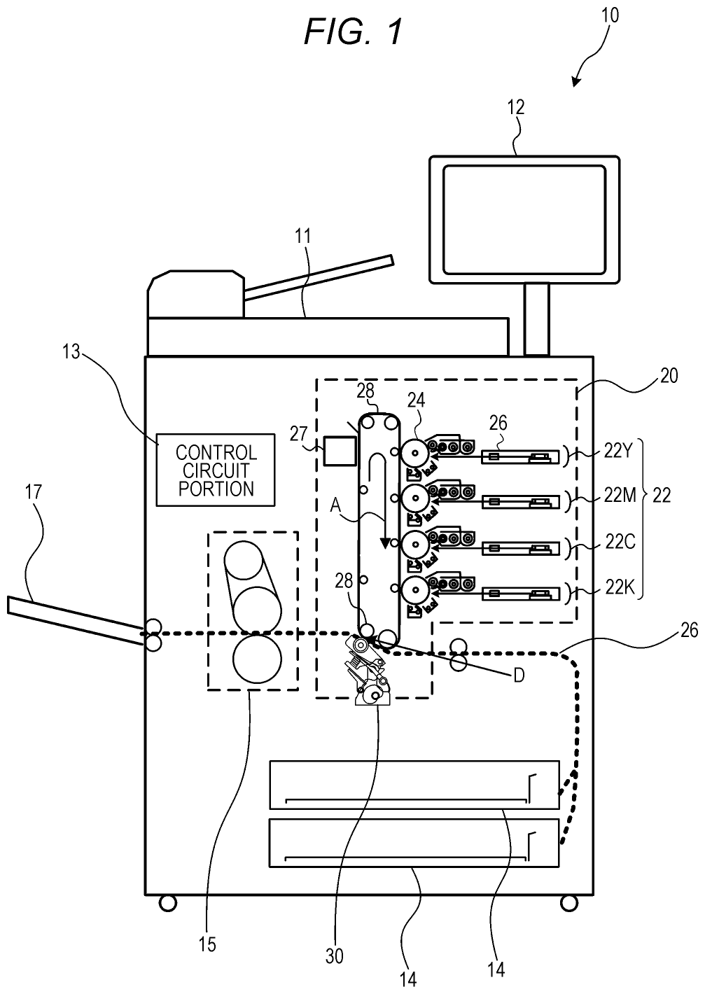

FIG. 1 illustrates a schematic configuration of an image forming apparatus 10 including a secondary transfer device according to an embodiment of the invention. The image forming apparatus 10 has a so-called multifunction machine that includes a copy function of forming an image obtained by optically reading an original document on a recording material such as recording paper and outputting the image, and a print function of forming an image rasterized on the recording paper based on print data input from the outside and outputting the image on the recording paper. The recording material is not limited to recording paper, but may be a film or cloth. Hereinafter, the recording material will be described as recording paper.

The image forming apparatus 10 includes a scanner portion 11 that optically reads an original document, an operation panel 12 that receives a user operation and displays various information, a control circuit portion 13 that controls the operation of the entire apparatus and performs image processing, an image forming portion 20 that forms an unfixed toner image on a recording material, a fixing device 15 that fixes an unfixed toner image to the recording paper, a sheet feed tray 14 that is capable of storing a large number of recording paper used for image formation, and a transport portion 16 that transports the sheet fed from the sheet feed tray 14.

The image forming portion 20 forms a toner image by an electrophotographic method. The image forming portion 20 forms an endless annular intermediate transfer belt 21 having a predetermined width and being wound around a plurality of rollers, image forming units 22Y, 22M, 22C, and 22K for each of yellow (Y), magenta (M), cyan (C), and black (K) to form (primary-transfer) the toner images of color components formed on the outer peripheral surface of the intermediate transfer belt, and a secondary transfer device 30 for secondarily transferring the toner image formed in the outer peripheral surface of the intermediate transfer belt 21 onto the recording paper. Further, the image forming units 22Y, 22M, 22C, and 22K for each color are collectively referred to as an image forming unit 22.

The image forming units 22Y, 22M, 22C, and 22K have different colors of toner used but have the same structure. The image forming units 22Y, 22M, 22C, and 22K each have a cylindrical photosensitive drum 24 as an electrostatic latent image carrier on which an electrostatic latent image is formed the surface, and a charging device, a developing device, a transfer device, a photosensitive drum cleaning device, and the like are arranged around the drum. A print head 26 is provided which includes a laser diode (LD) as a laser element, a polygon mirror, various lenses, a mirror, and the like.

In each of the image forming units 22Y, 22M, 22C, and 22K, the photosensitive drum 24 is driven by a drive unit, which is not illustrated, to rotate in a certain direction, and the charging device uniformly charges the photosensitive drum 24, and the print head 26 scans the photosensitive drum 24 with a laser beam controlled to be on/off in accordance with a drive signal based on image data of a corresponding color to form an electrostatic latent image on the surface of the photosensitive drum 24.

The developing device performs a developing step of developing the electrostatic latent image on the surface of the photosensitive drum 24 with toner. The toner image formed on the surface of the photosensitive drum 24 is transferred (primary-transferred) to the intermediate transfer belt 21 at a portion where the toner image contacts the intermediate transfer belt 21. The photosensitive drum cleaning device removes and collects the toner remaining on the surface of the photosensitive drum 24 by rubbing with a blade or the like after the transfer.

The intermediate transfer belt 21 wound around the plurality of rollers is driven by a drive unit, which is not illustrated, and rotates in the direction of arrow A in the drawing. In the course of the rotation, the toner images formed on the photosensitive drums 24 of the image forming units 22Y, 22M, 22C, and 22K of respective colors are sequentially transferred onto the intermediate transfer belt 21 and are superimposed to form a full-color image. The images are synthesized on the intermediate transfer belt 21. This toner image is transferred (secondary transfer) from the intermediate transfer belt 21 onto the recording paper by the secondary transfer device 30 arranged at the secondary transfer position D. Further, the toner remaining on the intermediate transfer belt 21 after the secondary transfer is removed from the intermediate transfer belt 21 by a cleaning device 27 provided downstream of the secondary transfer position D.

The fixing device 15 is provided in the middle of a transport path of the recording paper and downstream of the secondary transfer position D, and presses, heats, and fixes the toner image, which is transferred onto the surface of the recording paper at the secondary transfer position D, to the recording paper.

The transport portion 16 has a function of transporting the recording paper fed from the sheet feed tray 14 to a discharge tray 17 through the secondary transfer position D and the fixing device 15. The transport portion 16 includes a motor that drives the transport roller besides a transport roller and a guide that form a transport path. Although not illustrated, the transport portion 16 includes a sheet reversing mechanism for double-sided printing that reverses the recording paper exiting the fixing device 15 and sends the recording paper again to the transport path upstream of the secondary transfer position D.

The control circuit portion 13 includes a CPU (Central Processing Unit), a ROM (Read Only Memory), a RAM (Random Access Memory), and the like as main components. Each function as the image forming apparatus 10 is realized by the CPU executing the processing according to the program stored in the ROM. The control circuit portion 13 controls operations of the transport portion 16, the image forming portion 20, the secondary transfer device 30, and the like.

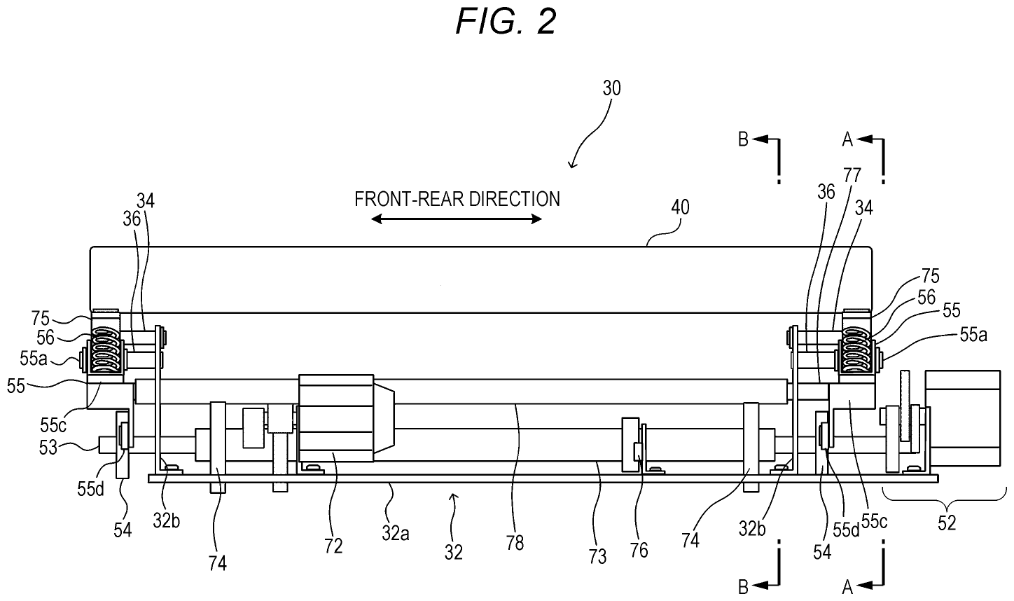

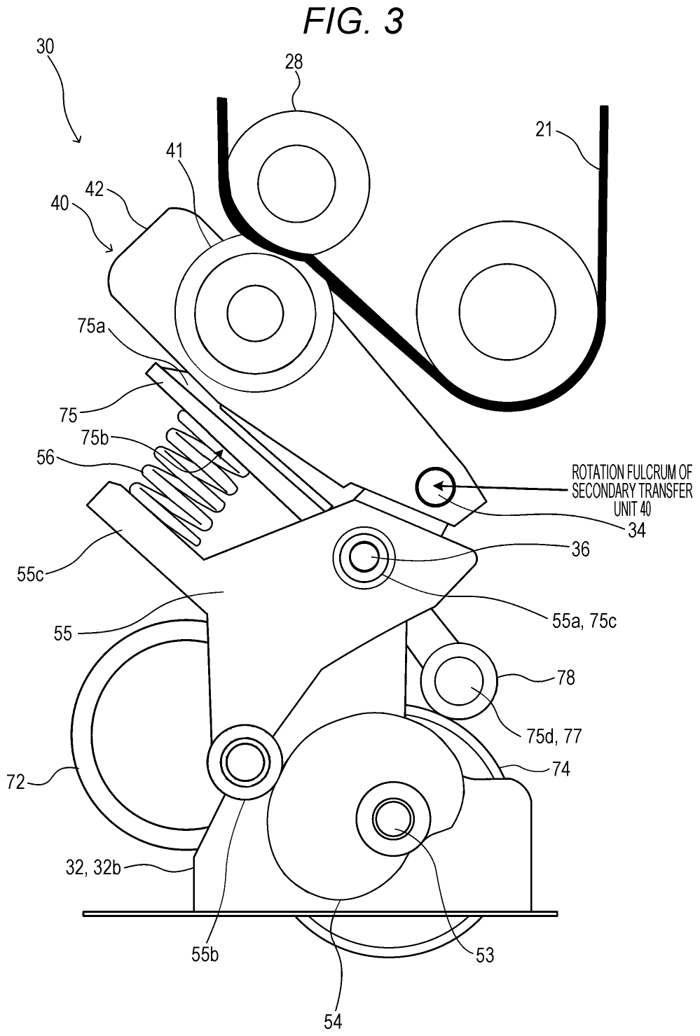

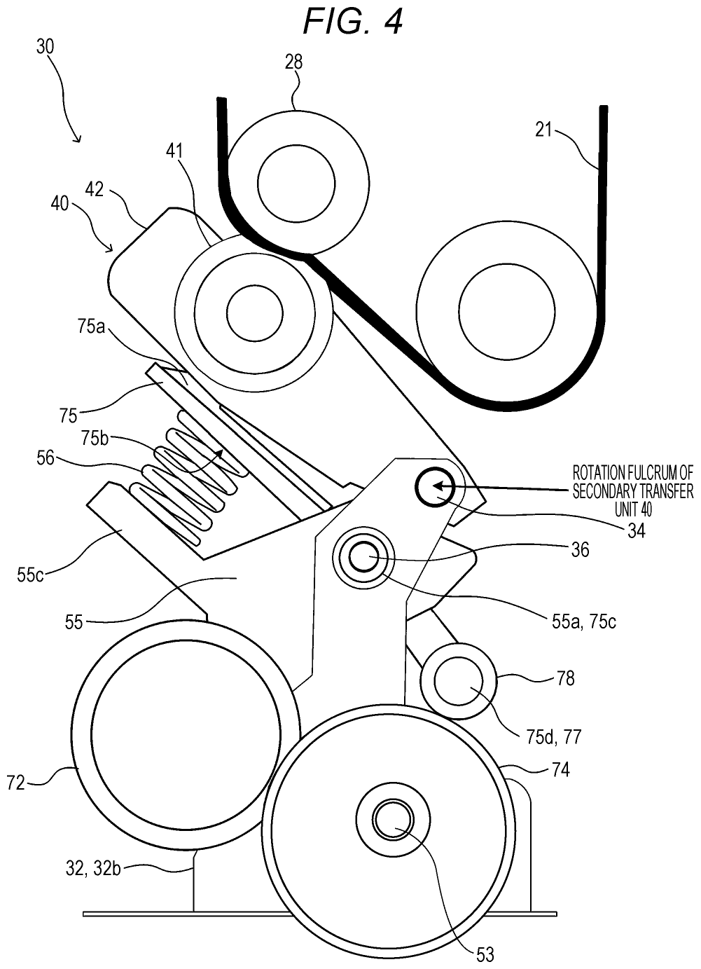

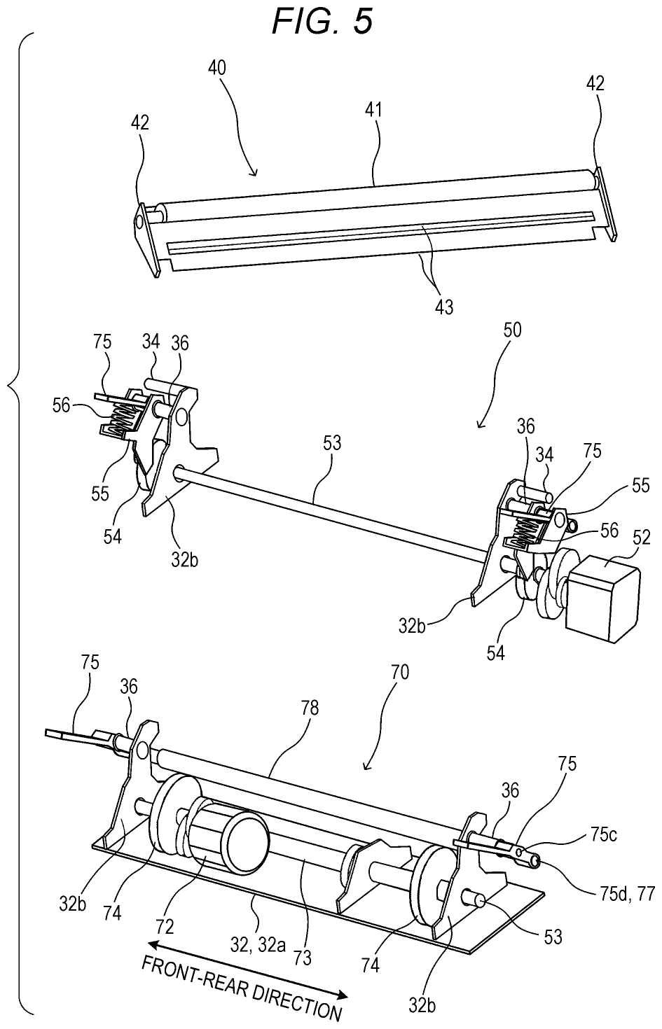

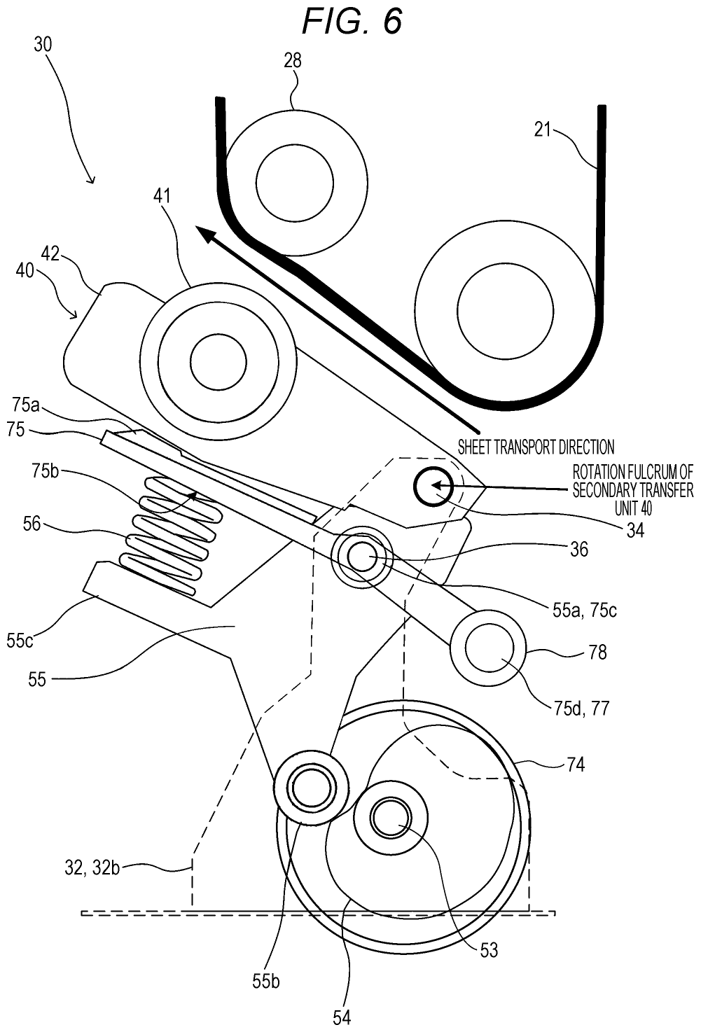

FIG. 2 is a left side view of the secondary transfer device 30 (a view of the secondary transfer device 30 viewed from the fixing device 15 side in FIG. 1), and FIG. 3 is a diagram corresponding to a cross section taken along line A-A in FIG. 2, and FIG. 4 is a view corresponding to the cross section taken along line B-B of FIG. 2. FIG. 5 is an exploded perspective view of the secondary transfer device 30. FIGS. 6 to 8 are diagrams illustrating the outline of the operation of a main part of the mechanical configuration of the secondary transfer device 30 extracted.

The secondary transfer device 30 presses a secondary transfer roller 41, having the width direction of the intermediate transfer belt 21 as the axial direction, against the outer peripheral surface of the intermediate transfer belt 21 at the secondary transfer position D, so that a transfer nip is formed by interposing the intermediate transfer belt 21 between the secondary transfer roller 41 and a roller (an opposite roller 28) disposed at a position facing the secondary transfer roller 41 in the plurality of rollers around which the intermediate transfer belt 21 is wound. Hereinafter, the width direction of the intermediate transfer belt 21 (the axial direction of the secondary transfer roller 41) is referred to as “front-rear direction.” Further, a relative position on the end side in the front-rear direction is called “outside”, and a relative position closer to the center in the front-rear direction is “inside.”

The secondary transfer roller 41 is incorporated in the secondary transfer unit 40, as illustrated in FIGS. 3 and 5. The secondary transfer unit 40 is configured by rotatably supporting the secondary transfer roller 41 on a frame member 42 and mounting a guide plate 43 and the like for guiding a sheet to the transfer nip to the frame member 42.

The secondary transfer device 30 is configured by mounting, to the frame member 32, the above-described secondary transfer unit 40, a pressure-releasing portion (pressure-releasing mechanism) 50 for displacing the secondary transfer unit 40 so as to be displaced to a pressing position at which the secondary transfer roller 41 is pressed against the intermediate transfer belt 21 to form a transfer nip, and a separated position at which the secondary transfer roller 41 is separated from the intermediate transfer belt 21, a first drive 52 including a motor and gears for driving the pressure-releasing portion 50, a high-speed depressurization portion (high-speed depressurization mechanism) 70 that temporarily decompresses the nip pressure, with which the secondary transfer roller 41 at the pressing position presses the intermediate transfer belt 21 interposed with the opposite roller 28, when the leading end and the tailing end of the sheet pass the secondary transfer location D (between the secondary transfer roller 41 and the intermediate transfer belt 21), and a second drive 72 including a motor and the like that drives the high-speed depressurization portion 70 (See FIG. 5).

As illustrated in FIGS. 2 and 5, the frame member 32 includes a rectangular plate-shaped bottom plate part 32a which is long in the front-rear direction of the secondary transfer device 30 and a pair of support plates 32b which erect from the vicinity of both ends in the front-rear direction of the bottom plate part 32a toward each other. Each of the opposing support plates 32b has its lower portion screwed to the bottom plate part 32a, and its upper portion is narrower than the lower portion. In the vicinity of the upper end of each support plate 32b, a unit support shaft 34 of a predetermined length for swingably supporting the secondary transfer unit 40 is provided so as to protrude outward in the front-rear direction.

The secondary transfer unit 40 is pivotally supported at both ends in the front-rear direction by the unit support shaft 34, and swings around the unit support shaft 34, so that the secondary transfer roller 41 having an axial center at a distance separated from the unit support shaft 34 to the downstream side in the sheet transport direction is displaced to a pressing position and a separating position.

The pressure-releasing portion 50 includes a pressing cam 54 which is supported by a rotation shaft 53 driven by a first drive 52 in the same direction as the axis of the secondary transfer roller 41 and rotates, and a pressing arm 55 that abuts on the pressing cam 54 and oscillates to displace the secondary transfer unit 40 between the pressing position and the separated position. The pressing cam 54 and the pressing arm 55 are provided at both ends in the front-rear direction corresponding to the respective support plates 32b.

The pressing arm 55 is configured such that a rotation fulcrum 55a at one end thereof is pivotally supported by a support shaft 36 (see FIGS. 2, 3, and 5) mounted to the support plate 32b slightly below the unit support shaft 34. The axial direction of the support shaft 36 that supports the rotation fulcrum 55a of the pressing arm 55 is the same as the axis of the secondary transfer roller 41.

As illustrated in FIGS. 3, 6 and the like, the rotation shaft 53 is rotatably supported by the support plate 32b at a position shifted slightly below the rotation fulcrum 55a of the pressing arm 55 to the upstream side in the sheet transport direction.

The pressing arm 55 has the above-described rotation fulcrum 55a at one end (upper end), and has a contact roller 55b (abutting member) at the other end (lower end) which comes into contact with the pressing cam 54 and becomes a force point, and a working arm 55c which protrudes sideways (upstream side in the sheet transport direction) on the way (see FIGS. 3 and 6).

A spring 56 extending upward spirally is mounted to the upper surface near the tip of the working arm 55c of the pressing arm 55, and the upper end of the spring 56 is bonded to the lower surface of the tip of a depressurization arm 75 described later. The pressing arm 55 has a working point where the spring 56 near the tip of the working arm 55c is mounted, and when the transfer nip is formed, the back surface of the secondary transfer unit 40 is pressed toward the opposite roller 28 via the spring 56 and the depressurization arm 75.

The pressure-releasing portion 50 includes two pressing cams 54 arranged at both ends in the axial direction (front-rear direction) of the secondary transfer roller 41 in the same phase, and by using the respective pressing arms 55 at both ends, the back surface of the secondary transfer unit 40 is simultaneously and similarly pressed at both ends in the front-rear direction, and the pressing is released.

The high-speed depressurization portion 70 includes a depressurization cam 74 which is mounted to a rotation shaft 73 driven by the second drive 72 and rotates in the same direction as the secondary transfer roller 41, and a depressurization arm 75 which abuts on the depressurization cam 74 and swings to displace the secondary transfer unit 40 at the pressing position in a direction where the nip pressure decreases. The rotation shaft 73 has a cylindrical shape, is fitted around the rotation shaft 53 of the pressure-releasing portion 50, and is coaxial with the rotation shaft 53.

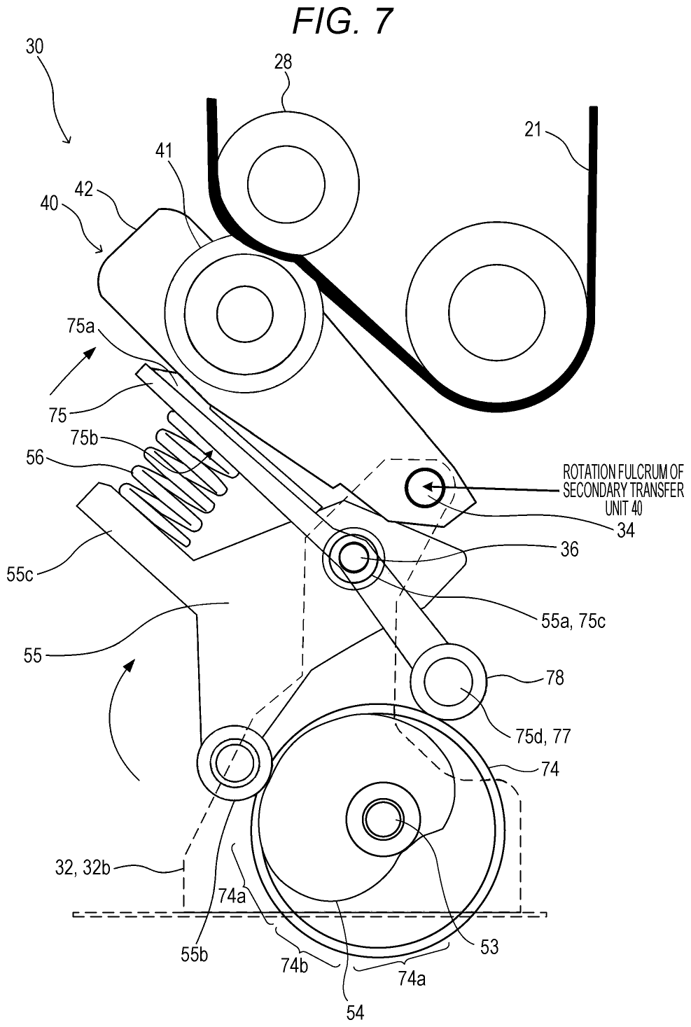

The depressurization cam 74 includes a slope 74a and a flat part 74b as a region of the outer periphery where a depressurization state where the nip pressure decreases (see FIG. 7). In the control of the high-speed depressurization portion 70, these regions are properly used according to the length of time for maintaining the depressurization.

The depressurization cam 74 and the pressing cam 54 aligned coaxially are in a positional relationship in which the projected images projected in the axial direction of the secondary transfer roller 41 are maximally overlapped. Further, the maximum diameter of the pressing cam 54 is smaller than the minimum diameter of the depressurization cam 74.

As illustrated in FIGS. 2, 5 and the like, the depressurization arms 75 are provided corresponding to the two pressing arms 55 at both ends in the front-rear direction. One end of the depressurization arm 75 is a pressing portion 75a that presses the back surface of the secondary transfer unit 40 toward the intermediate transfer belt 21 (see FIG. 3 and the like), and the back surface of the pressing portion 75a abuts on the upper end of the spring 56. The position where the upper end of the spring 56 is in contact is the working point 75b of the depressurization arm 75 in the depressurization operation.

The other end of the depressurization arm 75 is a force point 75d which receives a force from the depressurization cam 74. Here, the force points 75d at the ends of the two depressurization arms 75 provided separately at both ends in the front-rear direction corresponding to the pressing arms 55 are connected by a depressurization shaft 77 (connecting member) that is long in the front-rear direction. A cylindrical rotating body 78 that is long in the front-rear direction and freely rotates around the depressurization shaft 77 is fitted around the depressurization shaft 77.

When the rotating body 78 comes into contact with the depressurization cam 74, the depressurization arm 75 swings. By using the rotating body 78 as a member that abuts on the depressurization cam 74, friction with the depressurization cam 74 is reduced, and the durability of the depressurization cam 74 is improved. Further, a configuration in which the depressurization shaft 77 abuts on the depressurization cam 74 without providing the rotating body 78 may be employed.

A rotation fulcrum 75c of the depressurization arm 75 is located slightly closer to the end, where the depressurization shaft 77 is connected, from the center of the depressurization arm 75 in the longitudinal direction. The rotation fulcrum 75c is supported by the support plate 32b so as to be coaxial with the rotation fulcrum 55a of the pressing arm 55. In the depressurization arm 75, the distance from the rotation fulcrum 75c to the working point 75b (a portion where the spring 56 abuts on the back surface) at the time of depressurization is longer than the distance between the force point 75d (where the depressurization shaft 77 is connected) receiving the force from the depressurization cam 74 and the rotation fulcrum 75c. Thus, downsizing, and downsizing and cost reduction of the second drive 72 can be achieved.

In addition, the force point of the depressurization arm 75 (the rotating body 78 of the depressurization shaft 77), that is, a portion that comes into contact with the depressurization cam 74, is located between the rotation fulcrum 55a of the pressing arm 55 and the pressing cam 54. Accordingly, the main part of the high-speed depressurization mechanism 70 is disposed so as to be included in the pressure-releasing portion 50, and the apparatus is downsized.

As illustrated in FIG. 2, the depressurization cams 74 are respectively disposed so as to be near the inner sides of the two pressing cams 54 that are separately disposed at both ends in the front-rear direction. Further, a second drive 72 (a motor or the like) for rotating the rotation shaft 73 of the depressurization cam 74 and a position detection sensor 76 for detecting the angular position of the depressurization cam 74 are disposed inside the two depressurization cams 74.

A first drive 52 (a motor or the like) for rotating the rotation shaft 53, to which the pressing cam 54 is mounted, is mounted to one end of the secondary transfer device 30 in the front-rear direction. Specifically, it is mounted at a position outside the pressing cam 54 and the pressing arm 55.

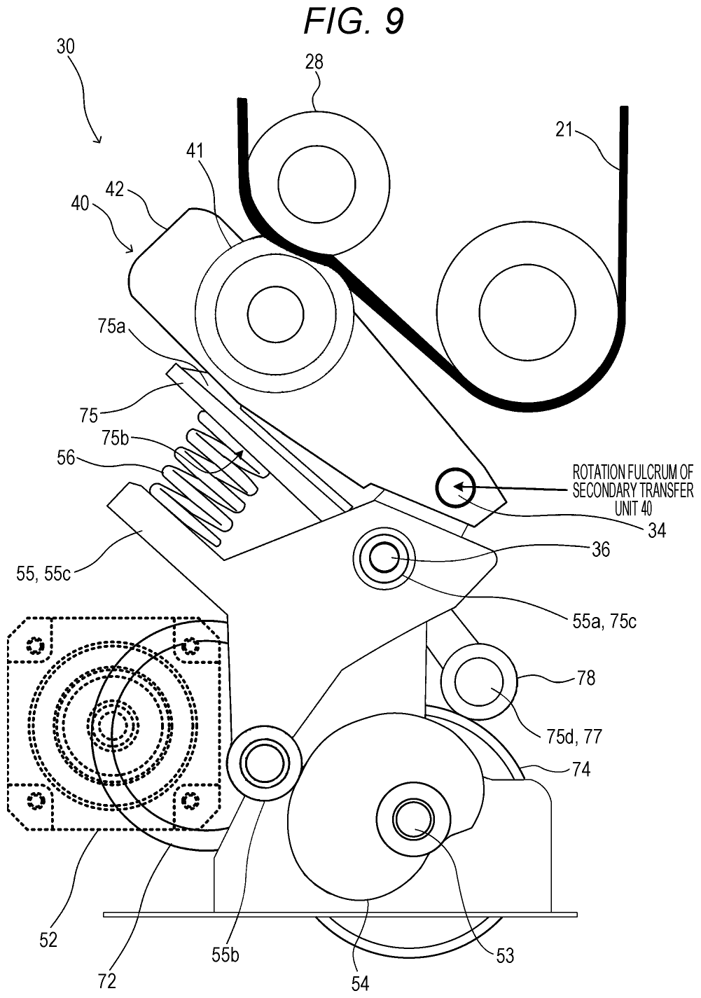

Further, as illustrated in FIG. 9, the first drive 52 and the second drive 72 are disposed so that the projected images when projected in the axial direction of the secondary transfer roller 41 overlap.

Further, in the image forming apparatus 10, the pressure-releasing portion 50 and the high-speed depressurization mechanism 70 of the secondary transfer device 30 are disposed on the opposite side of the intermediate transfer belt 21 with respect to the secondary transfer position D. As illustrated in FIGS. 1, 3 and the like, the secondary transfer device 30 (the pressure-releasing portion 50, the high-speed depressurization mechanism 70) is located below the secondary transfer position D. The intermediate transfer belt 21 is located above the secondary transfer position D. The pressure-releasing portion 50 and the high-speed depressurization mechanism 70 are located on the opposite side of the intermediate transfer belt 21 with respect to the secondary transfer position D.

Next, the operation of the secondary transfer device 30 will be described.

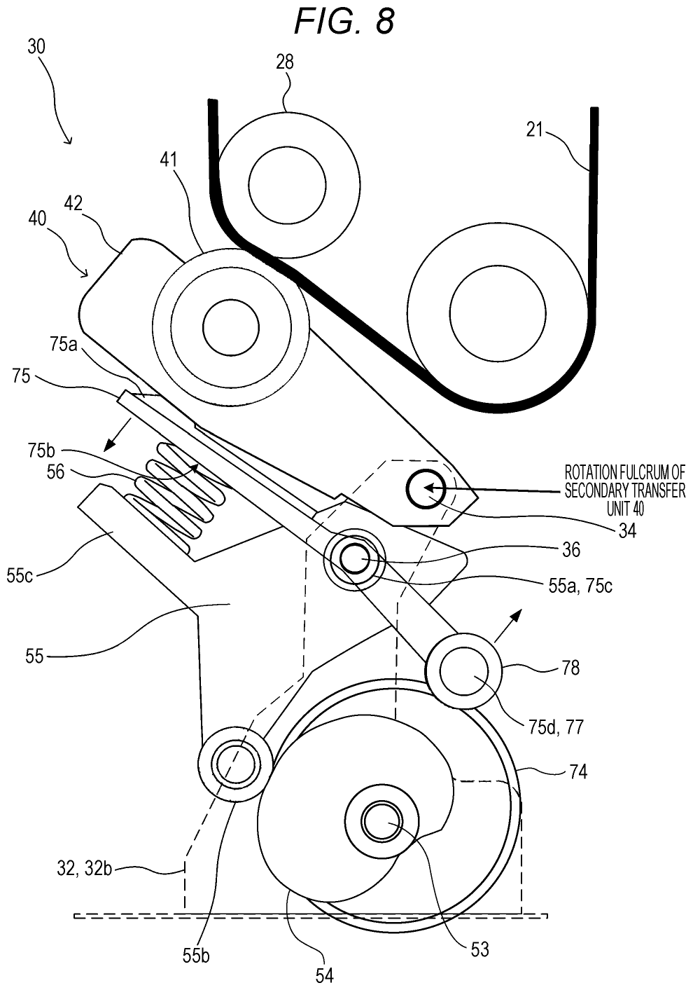

FIG. 6 illustrates a state in which the secondary transfer unit 40 is at the separated position. FIG. 7 illustrates a state in which the secondary transfer unit 40 is at the pressing position (pressure bonding state). FIG. 8 illustrates a state where the high-speed depressurization portion 70 operates to reduce the nip pressure.

When the secondary transfer device 30 rotates the rotation shaft 53 of the pressure-releasing portion 50 by the first drive 52, the pressing cam 54 mounted to the rotation shaft 53 rotates. The pressing arm 55 in which the contact roller 55b of the lower end abuts on the pressing cam 54 swings about the rotation fulcrum 55a in accordance with the angular position of the pressing cam 54.

When the secondary transfer unit 40 is displaced from the separation position to the pressing position, the pressing arm 55 rotates rightward (clockwise) from the position illustrated in FIG. 6, and presses the secondary transfer unit 40 toward the intermediate transfer belt 21 at the working point near the tip of the working arm 55c via the spring 56 and the depressurization arm 75 in this order. FIG. 7 illustrates a state in which depressurization by the high-speed depressurization portion 70 is not applied, and the depressurization cam 74 is at an angular position where it does not come into contact with the force point of the depressurization arm 75 (the rotating body 78 of the depressurization shaft 77). Accordingly, in this state, the depressurization arm 75 does not receive a force from the depressurization cam 74, and is displaced in accordance with the pressing operation of the pressure-releasing portion 50.

When the depressurization cam 74 of the high-speed depressurization portion 70 is rotated to a predetermined angular position while holding the pressing cam 54 of the pressure-releasing portion 50 at the position illustrated in FIG. 7, the depressurization cam 74 abuts on the force point (the rotating body 78 of the depressurization shaft 77) of the depressurization arm 75 and the depressurization arm 75 slightly rotates the rotation fulcrum 75c toward the center in the counterclockwise direction, and the pressing arm 55 is pushed back via the spring 56 at the working point 75b in the end opposite to the force point 75d with the rotation fulcrum interposed as illustrated in FIG. 8.

That is, the depressurization arm 75 reduces the nip pressure by blocking the pressing force exerted on the secondary transfer unit 40 by the pressing arm 55 via the spring 56. At this time, the axial distance between the opposite roller 28 and the secondary transfer roller 41 is somewhat shorter than the sum of the radius of the opposite roller 28 and the radius of the secondary transfer roller 41 when not in contact, and the nip pressure is generated by the elasticity of the outer peripheral members of the secondary transfer roller 41 and the opposite roller 28.

As described above, the secondary transfer device 30 according to the invention temporarily forms the depressurization state by the high-speed depressurization portion 70, which is a mechanism different from the pressure-releasing portion 50 that displaces the secondary transfer unit 40 to the pressing position. Therefore, a temporary depressurization state can be easily and smoothly formed at an appropriate timing.

That is, the pressurization operation is performed by the pressing arm 55 pressing the secondary transfer unit 40 via the spring 56 and the depressurization arm 75, and the depressurization operation is performed by displace the depressurization arm 75 such that the spring 56 pushes back toward the pressing arm 55. Therefore, a suitable degree of depressurization can be easily obtained compared to a mechanism in which the pressure-releasing portion 50 slightly displaces the pressing arm 55 toward the separation position to reduce the pressure. In addition, since the operation stroke of the depressurization arm 75 in the depressurization operation can be small, the depressurization operation and the depressurization release operation can be performed at high speed.

The control circuit portion 13 controls the second drive 72 of the high-speed depressurization portion 70 so that the pressure (nip pressure) is temporarily reduced when the leading edge and the trailing edge of the sheet pass the secondary transfer position D. Specifically, a sensor for detecting the leading and trailing ends of the sheet is provided slightly upstream in the sheet transport direction of the secondary transfer position D, and the angular position of the depressurization cam 74 is controlled by the second drive 72 to be the depressurization state only in a predetermined period before and after the leading and tailing ends of the sheet pass the secondary transfer position D with reference to the timing when the sensor detects the leading and tailing ends of the sheet.

The depressurization cam 74 is provided with the slope 74a and the flat part 74b on the outer circumference as a region where a depressurization state is formed. In the control of the high-speed depressurization portion 70, the control circuit portion 13 properly uses these regions according to a time for maintaining the depressurization.

More specifically, when maintaining the depressurization state for a certain period of time or more, the control circuit portion 13 sets the angular position of the depressurization cam 74 so that the flat part 74b of the depressurization cam 74 abuts on the force point (the rotating body 78 of the depressurization shaft 77) of the depressurization arm 75 to form the depressurization state, and stops the second drive 72 at the position to maintain the depressurization state.

On the other hand, if the time for maintaining the depressurization state is a short time less than a fixed time, the control circuit portion 13 forms the depressurization state using the slope 74a of the depressurization cam 74 where the force point of the depressurization arm 75 (the rotating body 78 of the depressurization shaft 77) abuts. Specifically, while the second drive 72 is being driven (while the depressurization cam 74 is being rotated), the slope 74a is continuously formed over an angle range in which the depressurization state occurs for a required time, and the control circuit portion 13 forms the depressurization state for the required time while driving the second drive 72 and maintaining the rotation of the depressurization cam 74.

For example, as illustrated in FIG. 7, when the slopes 74a are provided on both sides of the flat part 74b, the rotating body 78 abuts on the slope 74a of the depressurization cam 74, the flat part 74b, and the slopes 74a sequentially by continuing the rotation of the depressurization cam 74, and during that time, the depressurization state is continuously formed. If the rotation of the depressurization cam 74 is temporarily stopped when the rotating body 78 comes to the angular position where it abuts from the one slope 74a to the flat part 74b, the depressurization state can be extended during the temporary stop.

Since the depressurization cam 74 is provided with the flat part 74b, the depressurization state for a certain time or more can be formed by stopping the excitation of the motor, so that the power consumption can be reduced, and the motor can be reduced in size and power. Further, when the depressurization state is formed for a short time and released, the rotation of the depressurization cam 74 may be continued, so that the control of the second drive 72 is facilitated.

In addition, since the rotation shaft 53 holding the pressing cam 54 and the rotation shaft 73 holding the depressurization cam 74 are coaxial, the positional accuracy when controlling the angular position of these cams is improved.

The secondary transfer device 30 is downsized by the following configuration. First, the pressure-releasing portion 50 and the high-speed depressurization portion 70 are disposed so that the projected images when they are projected in the axial direction of the secondary transfer roller 41 overlap. More specifically, the projection images obtained by projecting the pressing cam 54 and the depressurization cam 74 in the axial direction of the secondary transfer roller 41 partially or entirely overlap. As a result, the area of the secondary transfer device 30 in a cross section perpendicular to the axis of the secondary transfer roller 41 is reduced.

In the present embodiment, the rotation shaft 53 of the pressing cam 54 and the rotation shaft 73 of the depressurization cam 74 are coaxial, so that the overlap between these cams is the largest.

In addition, as illustrated in FIG. 9, the first drive 52 and the second drive 72 are also disposed such that the projected images when projected in the axial direction of the secondary transfer roller 41 overlap, and the area of the secondary transfer device 30 in the cross section perpendicular to the axis of the secondary transfer roller 41 is reduced.

In addition, by disposing the pressure-releasing portion 50 and the high-speed depressurization portion 70 on the opposite side of the intermediate transfer belt with respect to the secondary transfer position, the rotating route of the intermediate transfer belt can be reduced, and the size of the image forming apparatus including the secondary transfer device can be reduced compared to the case where the pressure-releasing portion 50 and the high-speed depressurization portion 70 are provided inside the intermediate transfer belt. Further, by providing the pressure-releasing portion 50 and the high-speed depressurization portion 70 below the secondary transfer unit 40, the overall size of the image forming portion 20 including the secondary transfer device 30 is reduced.

Further, as illustrated in FIG. 2, a pressing arm 55 and a pressing cam 54 are provided at two locations separated at both ends in the front-rear direction (the axial direction of the secondary transfer roller 41), and a depressurization cam 74 is disposed inside these two portions. Therefore, the size of the apparatus in the front-rear direction can be reduced as compared to the case where the depressurization cam 74 is provided outside the pressing cam 54. In the configuration illustrated in FIG. 2, the depressurization cams 74 are provided at two locations near the inside of each of the pressing cams 54, separated from each other in the front-rear direction, so that a depressurization force is applied near the depressurization arm 75 to the rotating body 78 of the depressurization shaft 77, and the deflection of the depressurization shaft 77 can be reduced.

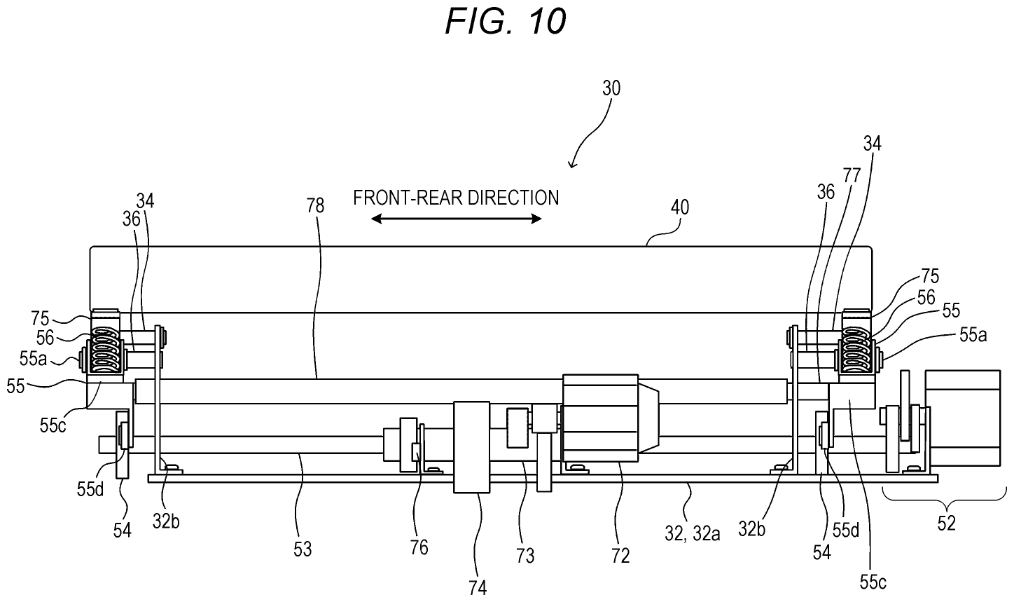

As illustrated in FIG. 10, the depressurization cam 74 may be configured such that only one depressurization cam 74 is disposed inside the two pressing cams 54 provided separately at both ends in the front depth direction and at the center in the front-rear direction. When the depressurization cams 74 are provided at two locations separated in the front-rear direction as illustrated in FIG. 2, there is a possibility that a difference occurs in the depressurization operations due to the shape and phase shift of the cams. In the configuration in which the depressurization cam 74 is provided only at a position of the center in the front-rear direction, the depressurization operation can be performed by synchronizing the depressurization arms 75 at both ends without being affected by the above difference.

In addition, as illustrated in FIG. 2, when two depressurization cams 74 are disposed separately at both ends in the front-rear direction, a position detection sensor 76 that detects the angular position of the second drive 72 and the depressurization cam 74 is disposed inside. Therefore, the size of the secondary transfer device 30 in the front-rear direction is reduced. In addition, as illustrated in FIG. 10, even in the configuration having one depressurization cam 74, the second drive 72 and the position detection sensor 76 are disposed inside the two pressing cams 54 divided at both ends in the front-rear direction. The size of the secondary transfer device 30 in the front-rear direction is reduced.

In addition, the rotation fulcrum 75c of the depressurization arm 75 is provided between the force point (a connection location of the depressurization shaft 77) at which the depressurization arm 75 receives a force from the depressurization cam 74 and the working point (a location where the tip of the spring 56 abuts) of the depressurization arm 75. Therefore, the direction in which the working point of the depressurization arm 75 applies a force to the spring 56 for depressurization and the direction in which the force point of the depressurization arm 75 is pressed during depressurization are reversed, and the degree of freedom of arrangement is increased. It is possible to select an arrangement that contributes to miniaturization.

Further, since the secondary transfer roller 41 is incorporated into the secondary transfer unit 40 to form a unit, the size, the maintainability, and the exchangeability of the high-speed depressurization portion 70 are improved. In addition, since the portion where the force for displacing the secondary transfer roller 41 is applied can be set at an arbitrary portion or the like of the frame member 42 of the secondary transfer unit 40, the degree of freedom of arrangement of each part is increased.

Further, the relationship between the pressing cam 54 and the depressurization cam 74 is coaxial, and the maximum diameter of the pressing cam 54 is smaller than the minimum diameter of the depressurization cam 74. Thus, the depressurization operation by the depressurization cam 74 can be performed irrespective of the position of the pressing cam 54. If the minimum diameter of the pressing cam 54 is larger than the maximum diameter of the depressurization cam 74, the pressing operation by the pressing cam 54 can be performed regardless of the position of the depressurization cam 74.

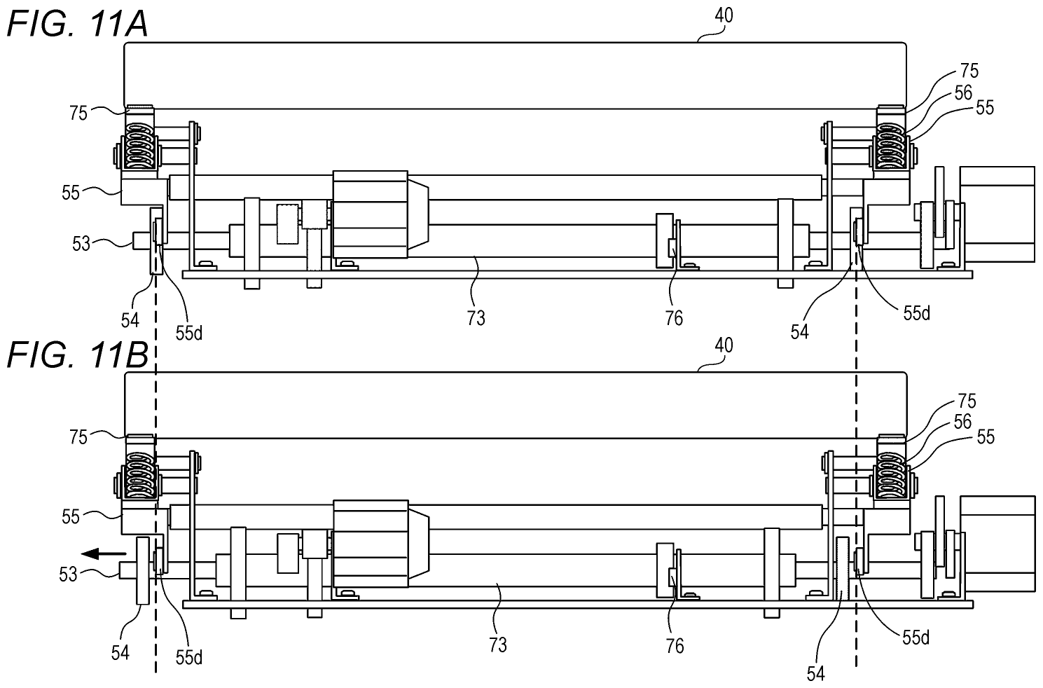

In addition, the rotation shaft 53 of the pressing cam 54 can be moved in the axial direction when a lock mechanism, which is not illustrated, is released, and the pressing cam 54 and the contact roller 55b on the pressing arm 55 side are displaced due to the movement. FIG. 11A illustrates a normal use state locked by the lock mechanism, and FIG. 11B illustrates a state in which the lock mechanism is released and the rotation shaft 53 and the rotation shaft 73 coaxial therewith are simultaneously moved to release the above engagement. In the case of FIGS. 11A and 11B, the pressing cam 54 and the contact roller 55b of the pressing arm 55 are displaced and disengaged from each other, so that the pressing arm 55 is in the separated position as illustrated in FIG. 6. Accordingly, the depressurization arm 75 is also displaced, and the rotating body 78 of the depressurization shaft 77 and the depressurization cam 74 are separated from each other, and the engagement is simultaneously released.

For example, when the secondary transfer device 30 is stopped in the pressing state or the depressurization state due to some trouble, the pressing state or the depressurization state is released by releasing the lock mechanism and moving the rotation shafts 53 and 73. The removal of a sheet can be performed smoothly.

Further, also in the high-speed depressurization portion 70, the depressurization cam 74 and the rotating body 78 of the depressurization shaft 77 are engaged in the normal use state in which the movement of the rotation shaft 73 in the front-rear direction is restricted by the lock mechanism, and the lock mechanism is released. Then, when the rotation shaft 73 is moved in the front-rear direction, the rotating body 78 of the depressurization shaft 77 and the depressurization cam 74 may be displaced and disengaged. For example, the diameter of the rotating body 78 may be made larger than other parts only in a portion corresponding to a position corresponding to the depressurization cam 74 in the normal use state.

The embodiment of the invention has been described with reference to the drawings. However, the specific configuration is not limited to that illustrated in the embodiment, and there are changes and additions within the scope of the invention, which are also included in the invention.

For example, the secondary transfer roller 41 may not be incorporated in the secondary transfer unit 40, and the pressure-releasing portion 50 may press the axis of the secondary transfer roller 41.

In the embodiment, the pressing arm 55 presses the secondary transfer unit 40 via the spring 56 and the depressurization arm 75, and the depressurization arm 75 pushes back the spring 56 when the pressure is reduced. For example, the pressing arm 55 may press the secondary transfer unit 40 via the spring 56, and the depressurization arm 75 may be engaged with a hook provided at both ends of the secondary transfer unit 40 to apply a force to the secondary transfer unit 40 in a direction toward the separation position. The shape of the spring 56 is not limited to the shape illustrated in the embodiment, and may be a leaf spring or the like, or may be an elastic body having necessary elasticity.

(Notes)

(Note 1)

A secondary transfer device for secondary-transferring a toner image primary-transferred on an outer peripheral surface of an endless annular intermediate transfer belt to a sheet at a predetermined secondary transfer position, the intermediate transfer belt having a predetermined width and being wound around a plurality of rollers and rotating, the secondary transfer device including,

a pressure-releasing mechanism that displaces a secondary transfer roller to a pressing position where the intermediate transfer belt is interposed and pressed between the secondary transfer roller and an opposite roller that abuts an inner peripheral surface of the intermediate transfer belt at the secondary transfer position, and a separation position separated from the outer peripheral surface of the intermediate transfer belt,

a first drive that drives the pressure-releasing mechanism,

a high-speed depressurization mechanism that temporarily depressurizes a nip pressure, at which the secondary transfer roller at the pressing position interposes and presses the intermediate transfer belt in a gap with respect to the opposite roller, when a leading end and a tailing end of a sheet pass between the secondary transfer roller and the intermediate transfer belt, and

a second drive that drives the high-speed depressurization mechanism,

wherein the pressure-releasing mechanism and the high-speed depressurization mechanism are disposed on an opposite side of the intermediate transfer belt with respect to the secondary transfer position.

(Note 2)

The secondary transfer device according to Note 1,

wherein the pressure-releasing mechanism and the high-speed depressurization mechanism are disposed such that projected images when projected in an axial direction of the secondary transfer roller overlap.

(Note 3)

The secondary transfer device according to Note 2, wherein a portion where the depressurization arm abuts on the depressurization cam is provided between a rotation fulcrum of the pressing arm and the pressing cam.

Although embodiments of the present invention have been described and illustrated in detail, the disclosed embodiments are made for purposes of illustration and example only and not limitation. The scope of the present invention should be interpreted by terms of the appended claims

What is claimed is:

1. A secondary transfer device for secondary-transferring a toner image primary-transferred on an outer peripheral surface of an endless annular intermediate transfer belt to a sheet at a predetermined secondary transfer position, the intermediate transfer belt having a predetermined width and being wound around a plurality of rollers and rotating, the secondary transfer device comprising:
a pressure-releasing mechanism that displaces a secondary transfer roller to a pressing position where the intermediate transfer belt is interposed and pressed between the secondary transfer roller and an opposite roller that abuts an inner peripheral surface of the intermediate transfer belt at the secondary transfer position, and a separation position separated from the outer peripheral surface of the intermediate transfer belt;
a first drive that drives the pressure-releasing mechanism;
a high-speed depressurization mechanism that temporarily depressurizes a nip pressure, at which the secondary transfer roller at the pressing position interposes and presses the intermediate transfer belt in a gap with respect to the opposite roller, when a leading end and a tailing end of a sheet pass between the secondary transfer roller and the intermediate transfer belt; and
a second drive that drives the high-speed depressurization mechanism,
wherein the pressure-releasing mechanism and the high-speed depressurization mechanism are arranged such that projected images when projected in an axial direction of the secondary transfer roller overlap.

2. The secondary transfer device according to claim 1,
wherein the pressure-releasing mechanism includes a pressing cam that is supported to a rotation shaft driven by the first drive in the same direction as an axis of the secondary transfer roller, and a pressing arm that abuts on the pressing cam and swings to displace the secondary transfer roller to the pressing position and the separation position,
the high-speed depressurization mechanism includes a depressurization cam that is supported to a rotation shaft driven by the second drive in the same direction as an axis of the secondary transfer roller, and a depressurization arm that abuts on the depressurization cam and swings to displace the axis of the secondary transfer roller in the pressing position in a direction in which the nip pressure decreases, and
the projected images of the pressing cam and the depressurization cam overlap with each other.

3. The secondary transfer device according to claim 2,
wherein the rotation shaft of the pressing cam and the rotation shaft of the depressurization cam are coaxial.

4. The secondary transfer device according to claim 3,
wherein a maximum diameter of the pressing cam is smaller than a minimum diameter of the depressurization cam.

5. The secondary transfer device according to claim 3,
wherein a minimum diameter of the pressing cam is larger than a maximum diameter of the depressurization cam.

6. The secondary transfer device according to claim 3,
wherein the pressing arm and the pressing cam are provided at two locations separated at both ends in an axial direction of the secondary transfer roller, and the depressurization cam is disposed inside these two locations.

7. The secondary transfer device according to claim 6,
wherein the depressurization arms are provided at two locations separated at both ends in the axial direction of the secondary transfer roller, and locations of force points of these depressurization arms are connected to each other by a connecting member,
the depressurization cam is disposed at a center in the axial direction of the secondary transfer roller, and
the connecting member abuts on the depressurization cam, and the depressurization arm swings.

8. The secondary transfer device according to claim 6,
wherein the depressurization arms are provided at two locations separated at both ends in the axial direction of the secondary transfer roller, and locations of force points of these depressurization arms are connected to each other by a connecting member,
the depressurization cams are disposed near an inside of the pressing cam, respectively, and
the connecting member abuts on the depressurization cam, and the depressurization arm swings.

9. The secondary transfer device according to claim 6,
wherein the depressurization cams are disposed near the inside of the pressing cam, respectively, and
a position detector that detects an angular position of the second drive and the depressurization cam is disposed inside the two depressurization cams.

10. The secondary transfer device according to claim 2,
wherein the depressurization arm abuts on the depressurization cam with a rotating body.

11. The secondary transfer device according to claim 2,
wherein a rotation fulcrum of the depressurization arm is located between a force point where the depressurization arm receives a force from the depressurization cam and a working point where the depressurization arm applies a force in a direction in which the nip pressure decreases.

12. The secondary transfer device according to claim 11,
wherein a distance from the rotation fulcrum to the working point is longer than a distance from the force point of the depressurization arm to the rotation fulcrum.

13. The secondary transfer device according to claim 1,
wherein the first drive and the second drive are disposed so that projected images when projected in an axial direction of the secondary transfer roller overlap.

14. The secondary transfer device according to claim 2,
wherein the pressing arm pushes the secondary transfer roller toward the pressing position through the spring and the depressurization arm in this order, and
the high-speed depressurization mechanism performs the depressurization by pushing the spring back to the pressing arm side with the depressurization arm.

15. The secondary transfer device according to claim 2,
wherein the depressurization cam includes a slope and a flat part on an outer periphery as a region where a depressurization state is formed, and
the slope and the flat part are properly used depending on a length of time to maintain depressurization.

16. The secondary transfer device according to claim 1,
wherein the secondary transfer roller is provided in a secondary transfer unit, and
the pressure-releasing mechanism and the high-speed depressurization mechanism displace the secondary transfer unit.

17. The secondary transfer device according to claim 16,
wherein the pressure-releasing mechanism and the high-speed depressurization mechanism are provided below the secondary transfer unit.

18. The secondary transfer device according to claim 2,
wherein the rotation shaft of the pressing cam can be moved in an axial direction when a lock mechanism is released, and the movement releases engagement between the pressing cam and an abutting member on the pressing arm side, or
the rotation shaft of the depressurization cam can be moved in the axial direction when the lock mechanism is released, and the movement releases the engagement between the depressurization cam and the abutting member on the depressurization arm side.

19. The secondary transfer device according to claim 3,
wherein, when the predetermined lock mechanism is released, the rotation shaft of the pressing cam and the rotation shaft of the depressurization cam can be simultaneously moved in the axial direction, and the movement causes the engagement between the pressing cam and the abutting member on the pressing arm side and the engagement between the depressurization cam and the abutting member on the depressurization arm side to be simultaneously released.
